(19) United States
(12) Patent Application Publication
(10) Pub. No.: US 2026/0189381 A1
(43) Pub. Date: Jul. 2, 2026

(54) System and method for dynamic partitioning, encryption, and compression based on text patterns

(71) Applicant: Bank of America Corporation, Charlotte, NC (US)

(72) Inventors: Jemlin Lucas, Coppell, TX (US); Suryanarayana Adivi, Telangana (IN); Pushkar Taneja, Telangana (IN)

(21) Appl. No.: 19/007,810

(22) Filed: Jan. 2, 2025

(51) Int. Cl. H04L 9/08

(52) U.S. Cl. CPC H04L 9/0869

(57) ABSTRACT

A system to encrypt, cipher, and compress a data packet is disclosed. The system, by a neural network trained on text patterns, partitions the data packet into data blocks based on text patterns. Each data block may correspond to a distinct text pattern. The system determines that a first data block comprises sensitive information based on a neural network trained on text cues related to sensitive information. In response, the system converts each letter in the determined portion into a mapped letter based on a second encryption key. The system identifies repetitive words in the first data block based on the first text pattern. In response, the system converts the repetitive words into a compressed representation. The system compresses other portions of the first data block. The system aggregates the first data block with other data blocks that may be encrypted, ciphered, compressed as well.

### TECHNICAL FIELD

The present disclosure relates generally to securing network communications, and more specifically to a system and method for dynamic partitioning, encryption, and compression based on text patterns.

### BACKGROUND

Data encryption and compression methods may be used to encrypt and compress data. With the expansion of wireless communication and new technologies, securing data packets from sophisticated cyber-attacks has become more challenging.

### SUMMARY

The disclosed system, described in the present disclosure, is particularly integrated into practical applications to provide technological improvements to conventional data partitioning, ciphering (e.g., obfuscation), compression, and network security techniques.

In conventional systems, data packets are encrypted with typical encryption and compression methods which has led to security vulnerabilities as bad actors evolve to more sophisticated cyber-attacks. Conventional encryption and compression techniques are often static—meaning that they rely on fixed patterns based on a predefined rule to encrypt and compress the data, respectively. Thus, this makes the data encryption and compression rigid, not adaptable, and easy to reverse engineer by bad actors. The conventional data compressions are not equipped to adapt to varying data formats or data patterns. As a result, the sensitive data is inadequately protected by conventional encryption and compression techniques.

The disclosed system is configured to provide a technical solution to these and other technical problems in data partitioning, ciphering (e.g., obfuscation), compression, and network security techniques. The technical advantages and improvements over the conventional techniques are described below in conjunction with certain embodiments of the disclosed system.

In some embodiments, the disclosed system implements a ciphering algorithm to identify contextual text patterns and sensitive information within the network data packet. In response, the disclosed system may apply a binary mask to isolate and partition the sensitive information, and cipher it to other characters. For example, neural networks that are trained on text patterns, text separation, text tokenization, and contextual cues are implemented to identify varying text patterns within the network data packet to identify the sensitive information within the data packet. In response, the neural network may transform the sensitive information to other characters. In this way, the system implemented a targeted data obfuscation (e.g., encryption or ciphering) on the sensitive information.

In some embodiments, the disclosed system implements a hybrid machine learning compression algorithm to identify contextual text patterns within a network data packet and the repetitive patterns within the network data packet. In response, the disclosed system may compress the identified repeated patterns. For example, neural networks that are trained on text patterns are used to identify the frequency of occurrence of each word within the network data packet. In this way, the system implements a targeted compression technique for the repeated patterns.

In some embodiments, by implementing the hybrid machine learning compression algorithm and ciphering algorithm based on text patterns, multiple layers of dynamic compression and encryption are implemented which makes the reverse engineering to access the original data packet practically unachievable for bad actors. In other words, unlike the conventional encryption (e.g., ciphering) methods which use static, fixed rules for encryption, the disclosed system adopts the ciphering map according to the text patterns of each data packet. In addition, unlike the conventional compression methods which use static, fixed rules for compression, the disclosed system adapts the compression process based on the specific text pattern, structure, and content of the data packet.

In some embodiments, the disclosed system is configured to reduce the size of the compressed data packet more than the conventional compression methods. For example, the hybrid machine learning compression algorithm may implement trained neural networks to identify repetitive patterns and apply context-aware compression rules to achieve higher compression ratios compared to the conventional compression methods. This, in turn, leads to reducing the physical memory storage that is required to store and maintain the compressed data packet, reducing the network communication latency due to the reduced size of the data packet, and requiring less network bandwidth for communicating the data packet in the network.

In some embodiments, unlike conventional data partitioning methods which use a static, fixed partitioning size for any type of data, the disclosed system is configured to adapt the partitioning of the data packet according to the varying text patterns within the data packet. The adaptive partitioning based on text patterns leads to have separated text patterns that may require different degrees or levels of security, such as sensitive information partition which requires a higher degree of security compared to other partitions.

In some embodiments, the disclosed system provides improvements to the network security because of the implementation of dynamic compression and encryption (e.g., ciphering) on the data packet. Thus, the reverse engineering of the data packet is more complex compared to when conventional compression and encryption are used.

Accordingly, the disclosed system provides the practical application of improving data partitioning, ciphering (e.g., obfuscation), compression, and network security by providing techniques to adapt to varying text patterns and data formats to identify and cipher sensitive information, and identify and compress repetitive text within the network data packets.

In some embodiments, a system comprises a memory operably coupled with a processor. The memory is configured to store a data packet, wherein the data packet is in form of text. The processor is configured to receive a request to encrypt the data packet. In response to receiving the request, the processor is further configured to encrypt the data packet with a first encryption key, wherein the first encryption key is generated by a random key generator. The processor is further configured to determine, by a first neural network trained on text patterns, a set of text patterns within the data packet. The set of text patterns indicates content of various portions of the data packet. Each of the set of text patterns is represented by an embedding vector comprising numerical values. The processor is further configured to partition, based at least in part upon the determined set of text patterns, the data packet into a plurality of data blocks. Each data block corresponds to a distinct text pattern from within the data packet. Each data block comprises a plurality of letters. The processor is further configured to determine, by a second neural network trained on text cues related to sensitive information and based at least in part upon a first text pattern associated with a first data block, that the first data block comprises a portion that represents sensitive information. The processor is further configured to convert each letter in the portion of the first data block into a respective mapped letter, wherein the respective mapped letter is determined based at least in part upon a second encryption key. The processor is further configured to identify, based at least in part upon the first text pattern associated with the first data block, a set of repetitive words within the first data block. The processor is further configured to convert the set of repetitive words into a compressed representation of the set of repetitive words, wherein the compressed representation is in a data structure different from the set of repetitive words. The processor is further configured to generate an encrypted, compressed first data block by aggregating the compressed representation of the set of repetitive words with a rest of the first data block. The processor is further configured to aggregate the encrypted, compressed first data block with the rest of the plurality of data blocks, wherein aggregating the encrypted, compressed first data block with the rest of the plurality of data blocks comprises appending each data block with a unique header bit-field that indicates a position of a respective data block in a sequence of the plurality of data blocks.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system configured to implement a hybrid machine learning compression algorithm and a ciphering algorithm to dynamically partition, compress, and cipher network data packets based on text patterns;

FIG. 2 illustrates an example operational flow of the system of FIG. 1 to implement a hybrid machine learning compression algorithm and a ciphering algorithm to dynamically partition, compress, and cipher network data packets based on text patterns; and

FIG. 3 illustrates an example flow chart of a method of the system of FIG. 1 to implement a hybrid machine learning compression algorithm and a ciphering algorithm to dynamically partition, compress, and cipher network data packets based on text patterns.

### DETAILED DESCRIPTION

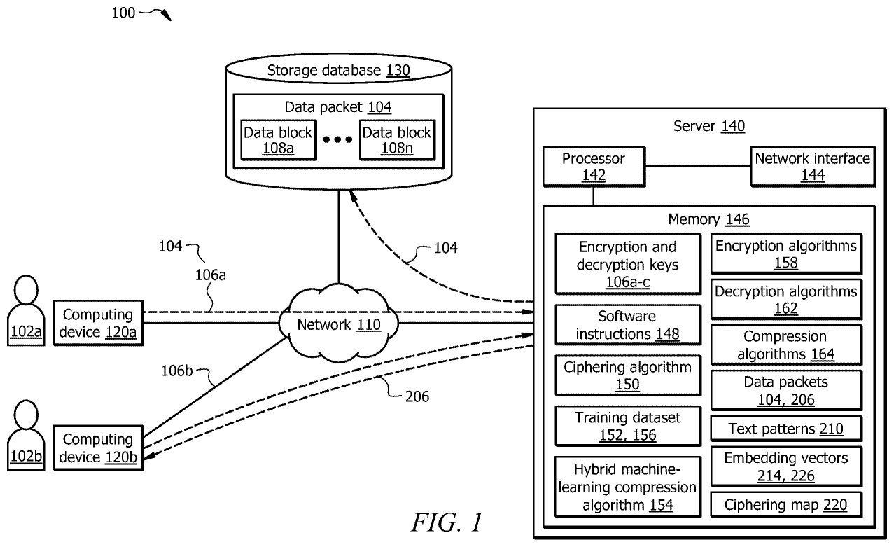

As described above, previous technologies fail to provide efficient and reliable solutions to partition, compress, and cipher network data packets. Embodiments of the present disclosure and its advantages may be understood by referring to FIGS. 1 through 3. FIGS. 1 through 3 are used to describe systems and methods to partition, compress, and cipher network data packets, according to some embodiments.

### System Overview

FIG. 1 illustrates an embodiment of a system 100 that is generally configured to address certain technical problems in network security by implementing a hybrid machine learning compression algorithm 154 and a ciphering algorithm 150 to dynamically partition, compress, and cipher network data packets 104 based on text patterns within the data packet 104. In some embodiments, the system 100 comprises a server 140 communicatively coupled with one or more computing devices 120a-b and a storage database 130 via a network 110. The network 110 enables the communication among the components of the system 100. Each of the computing devices 120a-b may be used to communicate with other components of the system 100. The storage database 130 is configured to store information that may be used by other components of the system 100. The server 140 is configured to evaluate network data packets 104, identify portions that include sensitive information, in response, cipher the identified sensitive information to other obfuscated text, identify repetitive patterns (e.g., repetitive words and/or sentences), compress the identified repetitive patterns, and store the decrypted, ciphered, and compressed data packets 104 in the storage database 130. If a request to access the data packet 104 is received, the server 140 may retrieve the data packet 104 from the storage database 130 and reverse the initial operations to reconstruct the original data packet 104. In other embodiments, system 100 may not have all of the components listed and/or may have other elements instead of, or in addition to, those listed above.

In general, the disclosed system 100 provides technological improvements to conventional data partitioning, ciphering (e.g., obfuscation), compression, and network security techniques. In conventional systems, data packets are encrypted with typical encryption and compression methods which has led to security vulnerabilities as bad actors evolve to more sophisticated cyber-attacks. Conventional encryption and compression techniques are often static—meaning that they rely on fixed patterns based on a predefined rule to encrypt and compress the data, respectively. Thus, this makes the data encryption and compression rigid, not adaptable, and easy to reverse engineer by bad actors. The conventional data compressions are not equipped to adapt to varying data formats or data patterns. As a result, the sensitive data is inadequately protected by conventional encryption and compression techniques.

The disclosed system is configured to provide a technical solution to these and other technical problems in data partitioning, ciphering (e.g., obfuscation), compression, and network security techniques. The technical advantages and improvements over the conventional techniques are described below in conjunction with certain embodiments of the disclosed system.

In some embodiments, the disclosed system implements a ciphering algorithm to identify contextual text patterns and sensitive information within the network data packet 104. In response, the disclosed system may apply a binary mask to isolate and partition the sensitive information, and cipher it to other characters. For example, neural networks that are trained on text patterns, text separation, text tokenization, and contextual cues are implemented to identify varying text patterns within the network data packet to identify the sensitive information within the data packet 104. In response, the neural network may transform the sensitive information to other characters. In this way, the system 100 implemented a targeted data obfuscation (e.g., encryption or ciphering) on the sensitive information.

In some embodiments, the disclosed system 100 implements a hybrid machine learning compression algorithm 154 to identify contextual text patterns 210 within a network data packet 104 and the repetitive patterns 222 within the network data packet. In response, the disclosed system may compress the identified repeated patterns. For example, neural networks that are trained on text patterns are used to identify the frequency of occurrence of each word within the network data packet 104. In this way, the system 100 implements a targeted compression technique for the repeated patterns.

In some embodiments, by implementing the hybrid machine learning compression algorithm 154 and ciphering algorithm 15 based on text patterns, multiple layers of dynamic compression and encryption are implemented which makes the reverse engineering to access the original data packet 104 practically unachievable for bad actors. In other words, unlike the conventional encryption (e.g., ciphering) methods which use static, fixed rules for encryption, the disclosed system 100 adopts the ciphering map according to the text patterns of each data packet 104. In addition, unlike the conventional compression methods which use static, fixed rules for compression, the disclosed system 100 adapts the compression process based on the specific text pattern, structure, and content of the data packet 104.

In some embodiments, the disclosed system 100 is configured to reduce the size of the compressed data packet 104 more than the conventional compression methods. For example, the hybrid machine learning compression algorithm 154 may implement trained neural networks to identify repetitive patterns and apply context-aware compression rules to achieve higher compression ratios compared to the conventional compression methods. This, in turn, leads to reducing the physical memory storage that is required to store and maintain the compressed data packet 104, reducing the network communication latency due to the reduced size of the data packet 104, and requiring less network bandwidth for communicating the data packet 104 in the network 110.

In some embodiments, unlike conventional data partitioning methods which use a static, fixed partitioning size for any type of data, the disclosed system 100 is configured to adapt the partitioning of the data packet 104 according to the varying text patterns within the data packet 104. The adaptive partitioning based on text patterns leads to separated text patterns that may require different degrees or levels of security, such as sensitive information partition which require a higher degree of security compared to other partitions.

In some embodiments, the disclosed system 100 provides improvements to the network security because of the implementation of the dynamic compression and encryption (e.g., ciphering) on the data packet 104. Thus, the reverse engineering of the data packet 104 is more complex compared to when conventional compression and encryption are used.

Accordingly, the disclosed system provides the practical application of improving data partitioning, ciphering (e.g., obfuscation), compression, and network security by providing techniques to adapt to varying text patterns and data formats to identify and cipher sensitive information, and identify and compress repetitive text within the network data packets.

### System Components

### Network

Network 110 may be any suitable type of wireless and/or wired network. The network 110 may be connected to the Internet or public network. The network 110 may include all or a portion of an Intranet, a peer-to-peer network, a switched telephone network, a local area network (LAN), a wide area network (WAN), a metropolitan area network (MAN), a personal area network (PAN), a wireless PAN (WPAN), an overlay network, a software-defined network (SDN), a virtual private network (VPN), a mobile telephone network (e.g., cellular networks, such as 4G or 5G), a plain old telephone (POT) network, a wireless data network (e.g., Wi-Fi, WiGig, WiMAX, etc.), a long-term evolution (LTE) network, a universal mobile telecommunications system (UMTS) network, a peer-to-peer (P2P) network, a Bluetooth network, a near-field communication (NFC) network, and/or any other suitable network. The network 110 may include fiber optics, optical fibers, and the like to implement quantum communication channels. The network 110 may be configured to support any suitable type of communication protocol as would be appreciated by one of ordinary skill in the art.

### Example Computing Device

Each computing device 120 (e.g., each of computing devices 120a-b) may generally be any device that is configured to process data and interact with users. Examples of the computing device 120 include but are not limited to, a personal computer, a desktop computer, a workstation, a server, a laptop, a tablet computer, a mobile phone (such as a smartphone), smart glasses, Virtual Reality (VR) glasses, a virtual reality device, an augmented reality device, an Internet-of-Things (IoT) device, or any other suitable type of device. The computing device 120 may include a user interface, such as a display, a microphone, a camera, a keypad, or other appropriate terminal equipment usable by users.

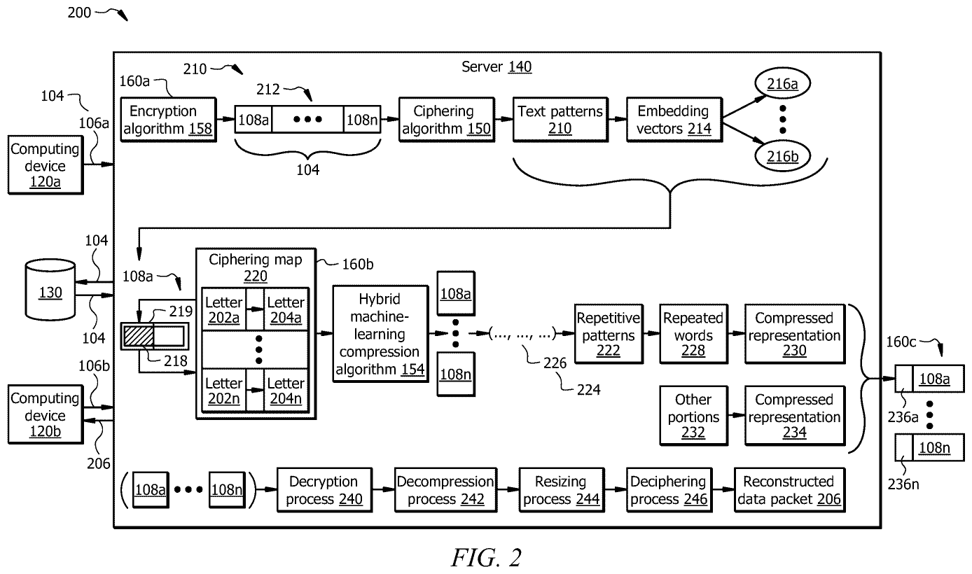

Each computing device 120 may include a hardware processor, memory, and/or circuitry configured to perform any of the functions or actions of the computing device 120 described herein. For example, the computing device 120 includes a processor in signal communication with a network interface and a memory. The memory stores software instructions (e.g., code) that, when executed by the processor, cause the processor to perform one or more operations of the computing device 120 described herein. The user 102a may use the computing device 120a to send a request 106 to encrypt and compress the data packet 104 to the server 140. In response, the server 140 may perform certain sequence of operations to encrypt and compress the data packet 104, and store it in the storage database 130. The user 102b may use the computing device 120b to send a request 106b to decrypt and decompress the data packet 104 to the server 140. In response, the server 140 may perform certain sequence of operations to decrypt and decompress the data packet 104, and send it to the computing device 120b. These operations are described in greater details in conjunction with the operational flow of the system 100 described in FIG. 2.

### Example Storage Database

The storage database 130 may include any storage architecture configured to store data and communicate with other computing devices. Examples of the storage database 130 include, but are not limited to, a data warehouse, a network-attached storage cloud, a storage area network, and a storage assembly directly (or indirectly) coupled to one or more components of the system 100. The storage database 130 is configured to store data packets 104. Examples of a data packet 104 may include, but not limited to, text-based data, such as electronic mails (e-mails), phone text messages, software application log files, network communication records (e. g, details of data transfers, data routes in a network), transcribed phone or video calls among people, among others.

Each data packet 104 may include a set of data blocks 108a-n. Each data block 108a-n may include a portion of the data packet 104. In some examples, each data block 108a-n may be associated with the same block size. In some examples, each data block 108a-n may be associated with different block sizes depending on the content and context of a given data block. Each data block 108a-n may include a plurality of letters, words, text, code, binary bit streams, etc.

### Example Server

The server 140 generally includes a hardware computer system configured to encrypt, cipher, and compress data packets 104, and store the decrypted, ciphered, and compressed data packets 104 in the storage database 130. The server 140 may perform the reverse operations to reconstruct the original data packet 104. In certain embodiments, the server 140 may be implemented by a cluster of computing devices, such as virtual machines. For example, the server 140 may be implemented by a plurality of computing devices using distributed computing and/or cloud computing systems in a network. In certain embodiments, the server 140 may be configured to provide services and resources (e.g., data and/or hardware resources as described herein, etc.) to other components and devices.

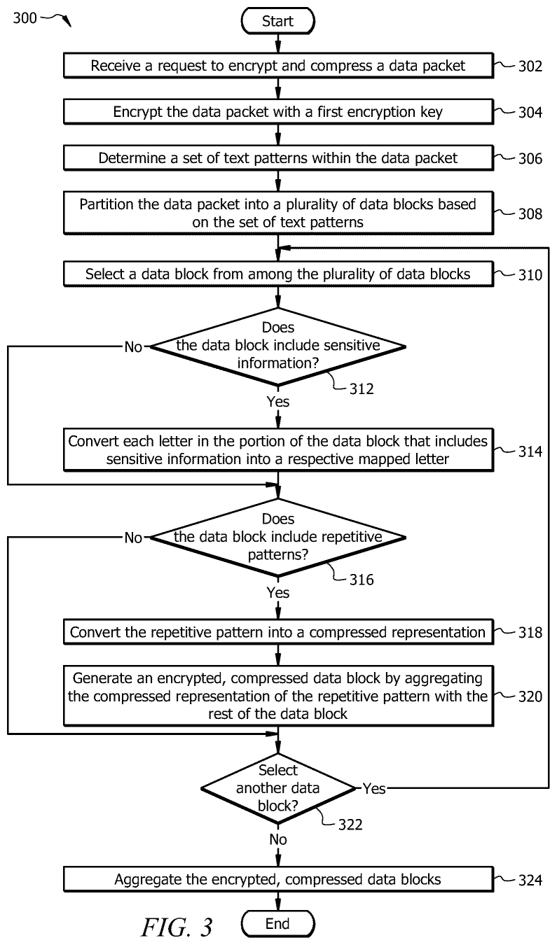

The server 140 may comprise a processor 142 operably coupled with a network interface 144 and a memory 146. The processor 142 comprises one or more processors. The processor 142 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). For example, one or more processors may be implemented in cloud devices, servers, virtual machines, and the like. The processor 142 may be a programmable logic device, a microcontroller, a microprocessor, or any suitable number and combination of the preceding. The one or more processors are configured to process data and may be implemented in hardware or software. For example, the processor 142 may be 8-bit, 16-bit, 32-bit, 64-bit, or of any other suitable architecture. The processor 142 may include an arithmetic logic unit (ALU) for performing arithmetic and logic operations. The processor 142 may register the supply operands to the ALU and store the results of ALU operations. The processor 142 may further include a control unit that fetches instructions from memory and executes them by directing the coordinated operations of the ALU, registers, and other components. The one or more processors are configured to implement various software instructions. For example, the one or more processors are configured to execute instructions (e.g., software instructions 148) to perform the operations of the server 140 described herein. In this way, the processor 142 may be a special-purpose computer designed to implement the functions disclosed herein. In an embodiment, the processor 142 is implemented using logic units, FPGAs, ASICs, DSPs, or any other suitable hardware. The processor 142 is configured to operate as described in FIGS. 1-3. For example, the processor 142 may be configured to perform one or more operations of the operational flow 200 as described in FIG. 2 and one or more operations of the method 300 as described in FIG. 3.

The network interface 144 is configured to enable wired and/or wireless communications. The network interface 144 may be configured to communicate data between the server 140 and other devices, systems, or domains. For example, the network interface 144 may comprise an NFC interface, a Bluetooth interface, a Zigbee interface, a Z-wave interface, a radio-frequency identification (RFID) interface, a WIFI interface, a local area network (LAN) interface, a wide area network (WAN) interface, a metropolitan area network (MAN) interface, a personal area network (PAN) interface, a wireless PAN (WPAN) interface, a modem, a switch, and/or a router. The processor 142 may be configured to send and receive data using the network interface 144. The network interface 144 may be configured to use any suitable type of communication protocol.

The memory 146 may be a non-transitory computer-readable medium. The memory 146 may be volatile or non-volatile and may comprise read-only memory (ROM), random-access memory (RAM), ternary content-addressable memory (TCAM), dynamic random-access memory (DRAM), and/or static random-access memory (SRAM). The memory 146 may include one or more of a local database, a cloud database, a network-attached storage (NAS), etc. The memory 146 comprises one or more disks, tape drives, or solid-state drives, and may be used as an overflow data storage device, to store programs when such programs are selected for execution, and to store instructions and data that are read during program execution. The memory 146 may store any of the information described in FIGS. 1-3 along with any other data, instructions, logic, rules, or code operable to implement the function(s) described herein when executed by processor 142. For example, the memory 146 may store software instructions 148, encryption algorithms 158, decryption algorithms 162, encryption and decryption keys 160a-c, hybrid machine learning compression algorithm 154, training datasets 152 and 156, compression algorithms 164, ciphering algorithm 150, text patterns 210, ciphering map 220, embedding vectors 214 and 226, data packets 104 and 206, and/or any other data or instructions. The software instructions 168 may comprise any suitable set of instructions, logic, rules, or code operable to execute the processor 142 and perform the functions described herein, such as some or all of those described in FIGS. 1-3.

The ciphering algorithm 150 may be implemented by the processor 142 executing software instructions 148 and is generally configured to determine text patterns within the network data packet 104 (e.g., within each data block 108a-n), determine the sensitive information within the data packet 104 based on the determined text patterns, and convert (e.g., cipher or obfuscate) each letter in each portion of each data block 108 into a respective mapped letter. In some embodiments, the ciphering algorithm 150 may include Vigenère polyalphabetic substitution ciphers. In some embodiments, the ciphering algorithm 150 may include neural networks trained on text cues related to sensitive information, text cues related to non-sensitive information, text patterns related to sensitive information, text patterns related to non-sensitive information, contextual text features, such as linguistic features, among others. In some embodiments, the ciphering algorithm 150 may comprise a support vector machine, neural networks, random forest, k-means clustering, etc. The ciphering algorithm 150 may be implemented by a plurality of neural network layers, convolutional neural network layers, Long-Short-Term-Memory (LSTM) layers, Bi-directional LSTM layers, recurrent neural network layers, and the like. In some embodiments, the ciphering algorithm 150 may be implemented by a natural language processing machine learning algorithm, text processing machine learning algorithm, among others.

In some embodiments, the ciphering algorithm 150 may be implemented by unsupervised, semi-supervised, or supervised machine learning techniques. For example, the ciphering algorithm 150 may be trained by a training dataset 152 that includes annotated text samples, each labeled with a sensitive information label, such as personal information (e.g., names, serial numbers, and addresses) and other text samples, each labeled with a non-sensitive information label.

In the training process, the ciphering algorithm 150 is given a portion of the training dataset 152 to learn the association between each annotated text sample and its label by extracting a set of features from each given annotated text sample and associate/link it to its respective label. In this operation, the ciphering algorithm 150 may use any type of text analysis, such as word segmentation, sentence segmentation, word tokenization, sentence tokenization, and/or the like to learn the associations, correlations, and patterns between the extracted features that resulted in the respective annotated text sample being associated with its label. Through this process, the ciphering algorithm 150 may understand the patterns and contextual features that distinguish sensitive information from non-sensitive information and the association between each annotated text sample and its label. The patterns of sensitive information may be predefined, such as names of users, residential addresses, etc. The ciphering algorithm 150 may generate vector embeddings that represent the extracted features of each annotated text sample in a multi-dimensional vector space. The ciphering algorithm 150 uses the vector embeddings to cluster the portions of the text within the data block 108a-n that are determined to include sensitive information, and cluster other operations that are determined to not include sensitive information.

In the testing process, the ciphering algorithm 150 is given a testing piece of text that is unlabeled and is asked to determine whether the testing piece of text includes sensitive information. In response, the ciphering algorithm 150 may use the learned intelligence from the training process to analyze the testing piece of text by extracting its features, such as text patterns, linguistic structures, contextual cues, among others, and perform word tokenization and sentence segmentation. In response, the ciphering algorithm 150 may generate a vector embedding to represent the testing piece of text in the learned multi-dimensional vector space and determine to which cluster (e.g., a cluster of pieces of text that are determined to include sensitive information in the training process or a cluster of pieces of text that are determined to not include sensitive information). The ciphering algorithm 150 may determine to which cluster the testing piece of text belongs based on the distance (e.g., Euclidean distance) between the embedding vector of the testing of text and the center of each cluster in the vector space.

If the distance between the embedding vector of the testing text and the center of the sensitive information cluster is less than a threshold distance (e.g., less than 0.1, 0.2, etc.), the ciphering algorithm 150 classifies the text as including sensitive information. Otherwise, the ciphering algorithm 150 may classify the text as not including sensitive information. For example, if the given piece of text resembles common patterns of names, sensitive numbers, or addresses, the ciphering algorithm 150 may flag it as sensitive information and determine that it belongs to the cluster of sensitive information. The ciphering algorithm 150 may go through epochs of backpropagation to increase the accuracy of text clustering by revising and refining the parameters of its neural networks, such as weight and bias values.

The hybrid machine learning compression algorithm 154 may be implemented by the processor 142 executing software instructions 148 and is generally configured to identify text patterns and repetitive patterns within the data packet 104 (e.g., within each data block 108a-n). The hybrid machine learning compression algorithm 154 may use a combination of supervised learning techniques and contextual text analysis methods to identify text patterns and repetitive patterns within the data block 108a-n. In response, the hybrid machine learning compression algorithm 154 may compress the identified repetitive patterns. In some embodiments, the hybrid machine learning compression algorithm 154 may comprise a support vector machine, neural networks, random forest, k-means clustering, etc. The hybrid machine learning compression algorithm 154 may be implemented by a plurality of neural network layers, convolutional neural network layers, LSTM layers, Bi-directional LSTM layers, recurrent neural network layers, and the like. In some embodiments, the hybrid machine learning compression algorithm 154 may be implemented by a natural language processing machine learning algorithm, text processing machine learning algorithm, among others.

The hybrid machine learning compression algorithm 154 may be trained on a training dataset 156 which includes annotated text samples, each labeled with respective indications of repetitive text patterns, linguistic structures, and/or contextual cues. In the training process, the hybrid machine learning compression algorithm 154 may extract a set of features from each annotated text sample, such as word frequency of occurrence, sentence structure, and position information of each word within the data packet 104. In this process, the hybrid machine learning compression algorithm 154 may use any type of text analysis, such as word segmentation, sentence segmentation, word tokenization, sentence tokenization, and/or the like to learn the associations, correlations, and patterns between the extracted features that resulted in the respective annotated text sample being associated with its label.

The hybrid machine learning compression algorithm 154 may generate vector embeddings to represent the extracted features for each portion of the data block 108a-n in a multi-dimensional vector space and cluster each repetitive pattern together. The hybrid machine learning compression algorithm 154 may use the vector embeddings to cluster the portions of the text within the data block 108a-n that are determined to be repeated, and cluster other operations that are determined to be repeated. For example, the instances of a first word (e.g., “hello”) may be clustered together, instances of a second word (e.g., “to”) are clustered together, etc.

In the testing process, the ciphering algorithm 150 is given a testing piece of text that is unlabeled and is asked to determine whether the testing text includes any repeated words and/or sentences. In response, the hybrid machine learning compression algorithm 154 may analyze the testing piece of text by extracting its features, such as word frequency of occurrence, sentence structure, and position information of each word, and perform text analysis operations, such as word tokenization and sentence segmentation to determine the text pattern, context, etc. The hybrid machine learning compression algorithm 154 may generate a vector embedding to represent the testing piece of text in the learned multi-dimensional vector space. In this operation, the hybrid machine learning compression algorithm 154 may determine to which cluster (e.g., a cluster of portions of each given text that are determined to be repeated in the training process or a cluster of other non-repeated text as determined in the training process) the testing text belongs, based on the distance (e.g., Euclidean distance) between the embedding vector of the testing text and the center of each cluster in the vector space. If the distance between the embedding vector of the testing text and the center of a cluster of repeated text is less than a threshold distance (e.g., less than 0.1, 0.2, etc.), the hybrid machine learning compression algorithm 154 may classify the testing text as including that repeated word or sentence. Otherwise, the hybrid machine learning compression algorithm 154 may classify the testing text as non-repetitive. The hybrid machine learning compression algorithm 154 may go through epochs of backpropagation to increase the accuracy of text clustering by revising and refining the parameters of its neural network, such as weight and bias values.

In some embodiments, after the repetitive words or sentences are identified and encoded into a compressed representation, the hybrid machine learning compression algorithm 154 may further compress the text, including both the encoded repetitive portions and the non-repetitive portions, using a secondary compression algorithm 164, such as the Lempel-Ziv-Markov chain algorithm (LZMA). This further reduces the size of the data packet, which in turn, reduces the network communication latency, reduces the memory space required to store it, and increases the data and network security of the data packet.

The compression algorithm 164 may be implemented by the processor 142 executing the software instructions 148 and is generally configured to compress the data packet to reduce its size. For example, the compression algorithm 164 may analyze the data packet 104 and identify sequences of characters or patterns that are repeated. These patterns are then stored in a dictionary structure, where each unique pattern is assigned or mapped to a corresponding reference or code (e.g., a binary number). The compression algorithm 164 may replace each occurrence of a repeated pattern in the data packet 104 with its respective reference from the dictionary. In some embodiments, the compression algorithm 164 may compress each repeated pattern into a respective American Standard Code for Information Interchange (ASCII) character, among others.

The encryption algorithms 158 may be implemented by the processor 142 executing the software instructions 148 and are generally configured to encrypt the data packet 104 using unique encryption keys 160 per each network data packet 104 at each given operation. The examples of the encryption algorithms 158, may include but are not limited to, Advanced Encryption Standard (AES) for symmetric encryption, Rivest-Shamir-Adleman (RSA) for asymmetric encryption, Rivest Cipher 4(RC4 ), Vigenère polyalphabetic substitution ciphers, among others.

The decryption algorithms 162 may be implemented by the processor 142 executing the software instructions 148 and are generally configured to decrypt the data packet 104 using unique decryption keys 160 per each network data packet 104 at each given operation. The decryption algorithms 162 may be the counterpart of the encryption algorithms 158. For example, if the data packet 104 is encrypted using AES with a specific encryption key 160, the corresponding decryption algorithm 162 would also employ AES with the same key 160 to decrypt the data packet 104. Similarly, if the RSA encryption algorithm 158 is used for a network data packet 104, the corresponding decryption algorithm 162 would use the paired RSA private key 160 to decrypt the data packet 104.

### Operational Flow for Encrypting and Compressing the Data Packet

FIG. 2 illustrates an example operational flow 200 of system 100 (see FIG. 1) for encrypting and compressing the data packet 104. In operation, the server 140 may begin the operational flow 200 when it receives a request 106a to encrypt and compress the data packet 104 from a computing device 120a. In response, the server 140 may perform a sequence of operations to encrypt and compress the received data packet 104 as described below. The server 140 may begin the sequence of operations by implementing the encryption algorithm 158 to encrypt the data packet 104 using the first encryption key 160a. In some embodiments, the first encryption key 160a may be generated by the encryption algorithm 158 using a random number generator, a random alphanumeric generator, a random string generator, etc. In response, in a decomposition process 212, the server 140 may partition the data packet 104 into a plurality of data blocks 108a-n.

### Partitioning and Ciphering

In some embodiments, the server 140 may perform the partitioning by executing the ciphering algorithm 150. In some embodiments, the partitioning operation of the data packet 104 into the plurality of data blocks 108a-n may be based on text pattern analysis (by the ciphering algorithm 150) of the data packet 104. In this process, in some embodiments, the server 140 may determine a set of text patterns 210 within the data packet 104 and use the text patterns 210 to partition the data packet 104. In this process, in some embodiments, the server 140 (e.g., via ciphering algorithm 150) may extract a set of features from the data packet 104 by a neural network that is trained on text patterns, among others, where the set of features may be represented by a set of embedding vectors 214, where each embedding vector 214 indicates a certain text pattern 210. The text patterns 210 may indicate the content and contextual information of various portions of the data packet 104. Each text pattern 210 may be represented by an embedding vector 214 that comprises numerical values. The text patterns 210 may include patterns of sensitive information, non-sensitive information, noises, pauses, fillers (e.g., “um”, “uh”, etc.), repetitive text, non-repetitive text, etc.

In some embodiments, the ciphering algorithm 150 may analyze the embedding vectors 214 to classify each portion of each data block 108a-n into a distinct cluster, such as sensitive information or non-sensitive information, based on the determined contextual cues and learned patterns from the training datasets 152, similar to that described in FIG. 1. For example, the ciphering algorithm 150 may cluster the embedding vectors 214 corresponding to sensitive information into a first cluster 216a, and cluster the embedding vectors 214 corresponding to non-sensitive information into a second cluster 216b. Other clusters 216 corresponding to different text patterns 210 may also be formed, such as noises, pauses, fillers (e.g., “um”, “uh”, etc.), repetitive text, non-repetitive text, etc. This information may be used to filter out undesired portions, such as noises, pauses, filters, etc. from further processing.

In response, the ciphering algorithm 150 may partition the data packet 104 into the plurality of data blocks 108a-n based on the determined text patterns 210. In some embodiments, each data block 108a-n may be associated with or corresponds to a distinct text pattern 210. In some embodiments, one or more data blocks 108a-n may have overlapping text pattern 210. Each data block 108a-n may include a plurality of alphabet letters, some of which may have gone through the ciphering process described above as including sensitive information.

In some embodiments, the server 140 may implement a neural network that is trained on text cues related to sensitive information, among others (e.g., a neural network of the ciphering algorithm 150) to determine which data block 180a-n includes portions that represent sensitive information. In this process, the server 140 (e.g., the ciphering algorithm 150) may evaluate each data block 108a-n to determine whether it includes any portion that may represent sensitive information, similar to that described above. For example, with respect to the first data block 108a, based on the first text pattern 210 and embedding vector 214 associated with the first data block 108a and using the ciphering algorithm 150, the server 140 may determine that the first data block 108a includes a portion 208 that represents sensitive information. In some embodiments, determining, based on the first text pattern 210 associated with the first data block 108a, that the first data block 108a comprises the portion 218 that represents sensitive information comprises applying a binary mask 219 to the first data block 108 to identify portions 218 that represent sensitive information, where the binary mask 219 isolates the portions 218 representing sensitive information from other portions the first data block 108a. In response, the server 140 may cipher the identified portion 218 into a ciphered (e.g., obfuscated) form. For example, the server 140 may use the ciphering map 220 to convert each letter 202a-n in the identified portion 218 into a respective mapped letter 204a-n, such as letter 202a to letter 204a, letter 202n to letter 204n, and so one, where each of the letters 202a-n, 204a-n is different alphabet letter.

In some embodiments, the respective mapped letter 102a-n is determined based on an encryption key 160, such a random seed value, a random number, etc. In this process, in some embodiments, the server 140 (e.g., via ciphering algorithm 150) may convert the data packet 104 into binary format and divide or split the binary representation of each 8-bit segment of the data packet 104 into four equal parts of 2-bit binary blocks. The server 140 may analyze each 2-bit block to determine its value and replace it with a respective character based on a predefined mapping between the binary values and alphabet characters. For example, a binary value of 00 may be replaced with the letter A, a binary value of 11 with the letter B, a binary value of 01 with the letter C, a binary value of 10 with D, and so on for other bits. In some examples, this mapping may or may not be sequential. In some embodiments, each character in the sequence of characters generated from this process may be substituted with another letter, where each character is replaced with another character based on a shared secret key 160b. For example, the letter A may be substituted with H, letter B with E, letter C with F, letter D with G, and so on for other letters according to the ciphering map 220. In some examples, the substitution process may be based on a predefined rule to, e.g., substitute a letter with a five letter ahead of it, etc. In some examples, the substitution process may be dynamic and change the ciphering map 220 based on parameters, such as the encryption key 160b, a random seed value, or the position of the character within the sequence. In this way, the ciphering algorithm 150 may create a new sequence of obfuscated characters.

### Revising the Data Block Sizes

In some embodiments, the server 140 may revise the size of one or more data blocks 108a-n, such that the data blocks 108a-n have a consistent block size. For example, if the server 140 determines that the size of the first data block 108a does not correspond to the size of a second data block 108n, the server 140 may resize at least one of the first data block 108a and/or the second data block 108n such that their sizes correspond to each other.

To increase the size of a data block 108, the server 140 may add paddings, such as a string of 0 bits to the data block 108. In some embodiments, in this process, the server 140 may convert the data in each data block 108a-n into binary format to have a unified format. For example, each data block 108 may be represented in 8-bit binary segments. If a data block 108 is smaller than others, the server 140 may append additional binary segments (e.g., padding).

### Detecting and Compressing Portions That Include Repetitive Patterns

The server 140 may implement the hybrid machine learning compression algorithm 154 to (1) identify and compress portions that include repetitive information (e.g., repeated text, words, sentences) and (2) compress the rest of each data block 108a-n. To this end, the hybrid machine learning compression algorithm 154 may analyze each data block 108a-n and use the text patterns 210 to detect repetitive patterns 222 within each data block 108a-n.

In this process, in some embodiments, the hybrid machine learning compression algorithm 154 may extract a set of features 224 from each data block 108a-n based on text analysis techniques, including word tokenization, word segmentation, sentence tokenization, sentence segmentation, among others. Each set of features 224 for a give data block 108a-n may indicate the frequency of occurrence of each word, and position information of each word within the data block, among others. The extracted features 224 of each data block 108a-n may be represented by an embedding vector 226 (e.g., feature vector) that comprises numerical values. Based on the extracted features 224, the hybrid machine learning compression algorithm 154 may determine which word(s) are repeated within a given data block 108a-n under evaluation. For example, with respect to the first data block 108a when it is under evaluation to determine whether it includes any repeated words, the server 140 (e.g., via the hybrid machine learning compression algorithm 154) may analyze the text patterns 210 of the first data block 108a and extract features 224 from the first data block 108a and determine whether they include an indication of repeated words 228. If it is determined that the first data block 108a includes a set of repetitive words 228, the hybrid machine learning compression algorithm 154 may convert the set of repetitive words 228 into a compressed representation 230 of the set of repetitive words 228. The compressed representation 230 of the set of repetitive words 228 may be in a data structure that is different from the set of repetitive words 228 which are in alphabet text format. For example, the compressed representation 230 may be in the form of a binary bit stream, etc.

The server 140 may perform similar operations for each other data blocks 108a-n to identify repetitive patterns 222, and repeated words 228, and compress them into respective compressed representation 230. The server 140 (e.g., via the hybrid machine learning algorithm 154 and/or compression algorithms 164) may compress the rest of each given data block 108a-n that are not repetitive words 228 to generate their compressed representation 234. For example, the server 140 (e.g., via the hybrid machine learning algorithm 154 and/or compression algorithms 164) may apply a sliding compression window along these portions to identify the repeating patterns. In this process, the server 140 may divide the remaining portions of data block 108 into smaller compression window blocks, convert each letter in each window into a respective binary bit, identify internal patterns where various sequences of letters are repeated, and replace them with shorter binary representations that correspond to the identified repeated sequences across the compression windows. In this manner, the server 140 may compress each data block 108a-b by compressing the repeated words 228 by a first compression technique and compressing the rest of the words by a second compression technique. Each instance of the repeated word 228 may be indicated based on its position within the data block 108a-n, e.g., the first instance of the word “hello” may be represented as 01x01, while the second instance of the same word may be represented as 01x02.

The server 140 may combine and aggregate the compressed portions in each data block 108a-n. For example, with respect to the first data block 108a, the server 140 may generate an encrypted, compressed first data block 108a by aggregating the compressed representation 230 of the set of repetitive words 228 with a rest of the first data block 108a, that are represented by the compressed representation 234.

The server 140 may perform similar operations on each data block 108a-n. In response, the server 140 may aggregate the encrypted, ciphered, and compressed data blocks 108a-n. For example, the server 140 may aggregate the encrypted, ciphered, and compressed first data block 108a with the rest of the plurality of data blocks 108 that may be encrypted, ciphered, and/or compressed similar to the first data block 108a.

In some embodiments, aggregating the encrypted, ciphered, and compressed first data block 108a with the rest of the plurality of data blocks 108 may include appending each data block 108a-n with a unique header bit-field 236 that indicates a position of a respective data block 10a-n in a sequence of the aggregated plurality of data blocks 108a-n. For example, the first header bit-field 236a may be added to the first data block 108a and the n-th header bit-field 236n may be added to the n-th data block 108n. The first header bit-field 236a may indicate that the data block 108a is the first block in the sequence and link the data block 108a to the next data block, and the second header bit-field 236n may indicate that the data block 108n is the last block in the sequence and link the block 108n to the preceding data block.

The server 140 may encrypt the aggregated data blocks 108a-n with an encryption algorithm 158, e.g., using a third encryption key 106c, to add another encryption layer to the data packet 104. The server 140 may communicate the aggregated data blocks 108a-n (e.g., in a network container as a data packet 104) to the storage database 130. The aggregated data blocks 108a-n may remain in the storage database 130. If the server 140 receives a request to retrieve the data packet 104, the server 140 may perform the reverse of the above discussed operations to decrypt, decompress, and decipher each data block 108a-n to reconstruct the original data packet 104.

### Decrypting and Decompressing the Data Packet

For example, assume that the server 140 receives a request 106b from the computing device 120b to decompress and decrypt the data packet 104. In response, the server 140 may retrieve the encrypted, ciphered, and compressed data packets 108a-n from the storage database 130 and begin the reverse operations in the reverse order descried above.

In the decompression process 240, the server 140 may decrypt the data packet 104 by a decryption algorithm 162, e.g., using a decryption key 160c, where the decryption algorithm 162 may be the counterpart of the encryption algorithm 158 used to encrypt the aggregated data blocks 108a-n in the last operation before communicating the data packet 104 to the storage database 130. The server 140 may decompress the data packets 108a-n to reverse the compression process described above. To this end, the server 140 may parse the header bit-fields 236a-n associated with each data block 108a-n to determine the sequence of the data blocks 108a-n within the aggregated data packet 104. In response, the server 140 may identify the position of each respective data block 108a-n within the sequence of the data blocks 108a-n.

In the decompression process 242, the server 140 may decompress each data block 108a-n while keeping the determined order of the data blocks 108a-n. The server 140 may generate decrypted, and decompressed data blocks 108a-n. For each data block 108a-n, the server 140 may identify the compressed representation 230 of the set of repetitive words 228. For example, with respect to the first data block 108a, the server 140 may use the mapping or dictionary associated with the compressed representation 230 to restore the original repetitive words 228, e.g., by implementing the hybrid machine learning compression algorithm 154, to reverse the compression performed to generate the compressed representation 230.

To restore the original form of the other portions 232 of the first data block 108a, the server 140 may reverse the sliding window compression process to determine the original sequence of letters which were mapped to compressed binary representations 234 by referencing to the internal dictionary created during the compression process. In response, the server 140 may replace the binary representations 234 with the original uncompressed portions 232, e.g., by implementing the reverse function of the compression algorithm 164. In this manner, the server 140 may decompress the first data block 108a. The server 140 combines the restored words 228 with the other restored portions 232 of the data block 108a.

The server 140 may perform similar operations on each data block 108a-n. When each data block 108a-n is decomposed, in the resizing process 244, the server 140 may reverse the size adjustment performed on any of the data blocks 108a-n to restore their original sizes. For example, if a padding was added to any data block 108a-n to increase its size, the server 140 may remove the padding bits.

### Deciphering Each Data Block

In the deciphering process 246, the server 140 may reverse the ciphering process described above on each data block 108a-n. The server 140 may identify which portions were ciphered based on a tag that was added to the ciphered portions. For example, with respect to the first data block 108a, the server 140 may convert each mapped letter 204a-n in the portion 218 of the first data block 108a back into the respective original letter 202a-n, respectively, by referencing the ciphering map 220 and based on the decryption key 160b. If the ciphering map 220 is dynamically generated based on the secret key 160b, the server 140 may recreate the ciphering map 220 using the secret key 160b. The server 140 may perform similar operations on each data block 108a-n. The result of the deciphering process 246 may be a representation of reconstructed data blocks 108a-n.

After each data block 108a-n is decrypted, decompressed, and deciphered, the server 140 may recombine the data blocks 108a-n, e.g., by aggregating the decrypted, decompressed, deciphered data block 108a with the rest of decrypted, decompressed, deciphered data blocks (if applied). In response, the server 140 may reconstruct the data packet 104 by generating the reconstructed data packet 206. The server 140 may use the header bit-fields 236a-n to reconstruct the data packet 104 according to the correct sequence of the original data. If an encryption algorithm 158 was used to encrypt the data packet 104, the server 140 may decrypt the reconstructed data packet 206 with the decryption key 160a, using the decryption algorithm 162 which is the counterpart of the encryption algorithm used to encrypt the data packet 104. The server 140 may communicate the reconstructed data packet 206 to the computing device 120b if the network address (e.g., Internet Protocol (IP) address) of the computing device 120b is among the authorized network addresses according to the firewall policy of the server 140.

### Evaluate the Reconstructed Data Packet

The server 140 may evaluate the reconstructed data packet 206 to determine whether the reverse operations of decryption, decompression, and deciphering were accurate. To this end, the server 140 may compare the reconstructed data packet 206 with the original data packet 104.

The server 140 may compare the content of the reconstructed data packet 206 with the content of the original data packet 104. For example, the server 140 may execute code (e.g., included in the software instructions 148) to analyze each data block 108a-n within the reconstructed data packet 206 to identify whether there is any discrepancy between the reconstructed data and the original data packet 104. The server 140 may compare individual letters, words, or sequences within the reconstructed data packet 206 to their counterpart entries in the original data packet 104. If it is determined that the reconstructed data packet 206 deviates from the original data packet 104, the server 140 may revise one or more parameters associated with one or more algorithms used in decryption, decompression, and/or deciphering. The reconstructed data packet 206 deviates from the original data packet 104 may determine that the reconstructed data packet 206 deviates from the original data packet 104 if more than a threshold number (e.g., 0, 1, 2, etc.) of the entries from the reconstructed data packet 206 does not correspond to their counterparts in the original data packet 104.

The server 140 may evaluate each algorithm by comparing the output of each of the reverse operations (e.g., decryption process 240, decomposition process 242, resizing process 244, and deciphering process 246) with the counterpart original operation. For example, the server 140 may update the weight and bias values of the hybrid machine learning compression algorithm 154 if it determined that the reverse operation of the hybrid machine learning compression algorithm 154 did not produce the original data (e.g., repeated words 228).

### Example Method for Implementing Dynamic Partitioning and Decompression Based on Text Patterns

FIG. 3 illustrates an example flowchart of a method 300 for implementing dynamic partitioning and decompression based on text patterns, according to some embodiments. Modifications, additions, or omissions may be made to method 300. Method 300 may include more, fewer, or other operations. For example, operations may be performed in parallel or in any suitable order. While at times it is discussed that the system 100, computing devices 120a-b, server 140, or components of any of thereof perform some operations, any suitable system or components of the system may perform one or more operations of the method 300. For example, one or more operations of method 300 may be implemented, at least in part, in the form of software instructions 148 of FIG. 1, stored on a tangible non-transitory machine-readable medium (e.g., memory 146 of FIG. 1) that when run by one or more processors (e.g., processor 142 of FIG. 1) may cause the one or more processors to perform operations 302-322.

At operation 302, the server 140 receives a request 106a to encrypt and compress the data packet 104, similar to that described in FIGS. 1-2.

At operation 304, the server 140 encrypts the data packet 104 with the first encryption key 160a, similar to that described in FIGS. 1-2.

At operation 306, the server 140 determines a set of text patterns 210 within the data packet 104, similar to that described in FIGS. 1-2.

At operation 308, the server 140 partitions the data packet 104 into a plurality of data blocks 108a-n based on the set of text patterns 210, among others, similar to that described in FIGS. 1-2.

At operation 310, the server 140 selects a data block 108 from among the plurality of data blocks 108a-n, similar to that described in FIGS. 1-2.

The server 140 may iteratively select a data block 108 if at least one data block 108 is left for evaluation, similar to that described in FIGS. 1-2.

At operation 312, the server 140 determines whether the data block 108 includes sensitive information, similar to that described in FIGS. 1-2. If it is determined that the data block 108 includes sensitive information, the method 300 proceeds to operation 314. Otherwise, the method 300 proceeds to operation 316, similar to that described in FIGS. 1-2.

At operation 314, the server 140 converts each letter 202a-n in the portion 218 of the data block 108 that includes sensitive information into a respective mapped letter 204a-n, similar to that described in FIGS. 1-2.

At operation 316, the server 140 determines whether the data block 108 includes repetitive patterns (e.g., repetitive sentences and/or words 228), similar to that described in FIGS. 1-2. If it is determined that the server data block 108 includes repetitive patterns, the method 300 proceeds to operation 318. Otherwise, the method 300 proceeds to operation 322, similar to that described in FIGS. 1-2.

At operation 318, the server 140 converts the repetitive pattern into a compressed representation 230, similar to that described in FIGS. 1-2.

At operation 320, the server 140 generates an encrypted, compressed data block 108 by aggregating the compressed representation 230 of the repetitive pattern with the rest of the data block 108, which may be ciphered and/or compressed, similar to that described in FIGS. 1-2.

At operation 322, the server 140 determines whether to select another data block 108. The server 140 determines to select another data block 108 if at least one data block 108 is left for evaluation, similar to that described in FIGS. 1-2. If it is determined that another data block 108 is left for evaluation, the method 300 returns to operation 310. Otherwise, the method 300 proceeds to operation 324, similar to that described in FIGS. 1-2.

At operation 324, the server 140 aggregates the encrypted, compressed data blocks 108a-n, similar to that described in FIGS. 1-2.

While several embodiments have been provided in the present disclosure, it should be understood that the system 100 and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented. In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein. To aid the Patent Office, and any readers of any patent issued on this application in interpreting the claims appended hereto, applicants note that they do not intend any of the appended claims to invoke 35 U.S.C. § 112(f), as it exists on the date of filing hereof, unless the words “means for” or “step for” are explicitly used in the particular claim.

1. A system comprising:
a memory configured to store a data packet, wherein the data packet is in form of text, and
a processor, operably coupled to the memory, and configured to:
receive a request to encrypt the data packet;
in response to receiving the request:
encrypt the data packet with a first encryption key, wherein the first encryption key is generated by a random key generator;
determine, by a first neural network trained on text patterns, a set of text patterns within the data packet, wherein:
the set of text patterns indicates content of various portions of the data packet; and
each of the set of text patterns is represented by an embedding vector comprising numerical values;
partition, based at least in part upon the determined set of text patterns, the data packet into a plurality of data blocks, wherein:
each data block corresponds to a distinct text pattern from within the data packet; and
each data block comprises a plurality of letters;
determine, by a second neural network trained on text cues related to sensitive information and based at least in part upon a first text pattern associated with a first data block, that the first data block comprises a portion that represents sensitive information;
convert each letter in the portion of the first data block into a respective mapped letter, wherein the respective mapped letter is determined based at least in part upon a second encryption key;
identify, based at least in part upon the first text pattern associated with the first data block, a set of repetitive words within the first data block;
convert the set of repetitive words into a compressed representation of the set of repetitive words, wherein the compressed representation is in a data structure different from the set of repetitive words;
generate an encrypted, compressed first data block by aggregating the compressed representation of the set of repetitive words with a rest of the first data block; and
aggregate the encrypted, compressed first data block with the rest of the plurality of data blocks, wherein aggregating the encrypted, compressed first data block with the rest of the plurality of data blocks comprises appending each data block with a unique header bit-field that indicates a position of a respective data block in a sequence of the plurality of data blocks.

2. The system of claim 1, wherein partitioning the data packet into the plurality of data blocks is further based at least in part upon a text pattern analysis of the data packet.

3. The system of claim 1, wherein determining, based at least in part upon the first text pattern associated with the first data block, that the first data block comprises the portion that represents sensitive information comprises applying a binary mask to the first data block to identify portions that represent sensitive information, wherein the binary mask isolates the portions representing sensitive information from other portions the first data block.

4. The system of claim 1, wherein identifying, based at least in part upon the first text pattern associated with the first data block, the set of repetitive words within the first data block comprises:
extracting a set of features from the first data block based on at least one of a word tokenization or a sentence tokenization, wherein:
the set of features indicates a frequency of occurrence of each word within the first data block; and
the set of features is represented by a feature vector comprising numerical values; and
determining, based at least in part upon the set of features, which words are repeated within the first data block.

5. The system of claim 1, wherein the processor is further configured to:
determine that a size of the first data block does not correspond to a size of a second data block; and
resize at least one of the first data block or the second data block such that the size of the first data block corresponds to the size of the second data block.

6. The system of claim 1, wherein the processor is further configured to:
receive a second request to decrypt and decompress the encrypted, compressed data packet; and
in response to receiving the second request:
retrieve the encrypted, compressed data packet;
decrypt the encrypted, compressed data packet using a first decryption key;
identify, based at least in part upon header bit-fields associated with the plurality of data blocks, the position of each respective data block within the sequence of the plurality of data blocks;
generate a decrypted, decompressed first data block by:
decompressing the first data block by converting the compressed representation of the set of repetitive words back into the set of repetitive words; and
converting each mapped letter in the portion of the first data block back into a respective original letter based at least in part upon a second decryption key;
reconstruct the data packet by aggregating the decrypted, decompressed first data block with the rest of the plurality of data blocks.

7. The system of claim 6, wherein the processor is further configured to:
compare the reconstructed data packet with an original data packet;
determine that the reconstructed data packet deviates from the original data packet; and
in response to determining that the reconstructed data packet deviates from the original data packet, revise one or more parameters associated with a hybrid machine learning compression algorithm.

8. A method comprising:
receiving a request to encrypt a data packet, wherein the data packet is in form of text; and
in response to receiving the request:
encrypting the data packet with a first encryption key, wherein the first encryption key is generated by a random key generator;
determining, by a first neural network trained on text patterns, a set of text patterns within the data packet, wherein:
the set of text patterns indicates content of various portions of the data packet; and
each of the set of text patterns is represented by an embedding vector comprising numerical values;
partitioning, based at least in part upon the determined set of text patterns, the data packet into a plurality of data blocks, wherein:
each data block corresponds to a distinct text pattern from within the data packet; and
each data block comprises a plurality of letters;
determining, by a second neural network trained on text cues related to sensitive information and based at least in part upon a first text pattern associated with a first data block, that the first data block comprises a portion that represents sensitive information;
converting each letter in the portion of the first data block into a respective mapped letter, wherein the respective mapped letter is determined based at least in part upon a second encryption key;
identifying, based at least in part upon the first text pattern associated with the first data block, a set of repetitive words within the first data block;
converting the set of repetitive words into a compressed representation of the set of repetitive words, wherein the compressed representation is in a data structure different from the set of repetitive words;
generating an encrypted, compressed first data block by aggregating the compressed representation of the set of repetitive words with a rest of the first data block; and
aggregating the encrypted, compressed first data block with the rest of the plurality of data blocks, wherein aggregating the encrypted, compressed first data block with the rest of the plurality of data blocks comprises appending each data block with a unique header bit-field that indicates a position of a respective data block in a sequence of the plurality of data blocks.

9. The method of claim 8, wherein partitioning the data packet into the plurality of data blocks is further based at least in part upon a text pattern analysis of the data packet.

10. The method of claim 8, wherein determining, based at least in part upon the first text pattern associated with the first data block, that the first data block comprises the portion that represents sensitive information comprises applying a binary mask to the first data block to identify portions that represent sensitive information, wherein the binary mask isolates the portions representing sensitive information from other portions the first data block.

11. The method of claim 8, wherein identifying, based at least in part upon the first text pattern associated with the first data block, the set of repetitive words within the first data block comprises:
extracting a set of features from the first data block based on at least one of a word tokenization or a sentence tokenization, wherein:
the set of features indicates a frequency of occurrence of each word within the first data block; and
the set of features is represented by a feature vector comprising numerical values; and
determining, based at least in part upon the set of features, which words are repeated within the first data block.

12. The method of claim 8, further comprising:
determining that a size of the first data block does not correspond to a size of a second data block; and
resizing at least one of the first data block or the second data block such that the size of the first data block corresponds to the size of the second data block.

13. The method of claim 8, further comprising:
receiving a second request to decrypt and decompress the encrypted, compressed data packet; and
in response to receiving the second request:
retrieving the encrypted, compressed data packet;
decrypting the encrypted, compressed data packet using a first decryption key;
identifying, based at least in part upon header bit-fields associated with the plurality of data blocks, the position of each respective data block within the sequence of the plurality of data blocks;
generating a decrypted, decompressed first data block by:
decompressing the first data block by converting the compressed representation of the set of repetitive words back into the set of repetitive words; and
converting each mapped letter in the portion of the first data block back into a respective original letter based at least in part upon a second decryption key;
reconstructing the data packet by aggregating the decrypted, decompressed first data block with the rest of the plurality of data blocks.

14. The method of claim 13, further comprising:
comparing the reconstructed data packet with an original data packet;
determining that the reconstructed data packet deviates from the original data packet; and
in response to determining that the reconstructed data packet deviates from the original data packet, revising one or more parameters associated with a hybrid machine learning compression algorithm.

15. A non-transitory computer-readable medium storing instructions that when executed by a processor, cause the processor to:
receive a request to encrypt a data packet, wherein the data packet is in form of text; and
in response to receiving the request:
encrypt the data packet with a first encryption key, wherein the first encryption key is generated by a random key generator;
determine, by a first neural network trained on text patterns, a set of text patterns within the data packet, wherein:
the set of text patterns indicates content of various portions of the data packet; and
each of the set of text patterns is represented by an embedding vector comprising numerical values;
partition, based at least in part upon the determined set of text patterns, the data packet into a plurality of data blocks, wherein:
each data block corresponds to a distinct text pattern from within the data packet; and
each data block comprises a plurality of letters;
determine, by a second neural network trained on text cues related to sensitive information and based at least in part upon a first text pattern associated with a first data block, that the first data block comprises a portion that represents sensitive information;
convert each letter in the portion of the first data block into a respective mapped letter, wherein the respective mapped letter is determined based at least in part upon a second encryption key;
identify, based at least in part upon the first text pattern associated with the first data block, a set of repetitive words within the first data block;
convert the set of repetitive words into a compressed representation of the set of repetitive words, wherein the compressed representation is in a data structure different from the set of repetitive words;
generate an encrypted, compressed first data block by aggregating the compressed representation of the set of repetitive words with a rest of the first data block; and
aggregate the encrypted, compressed first data block with the rest of the plurality of data blocks, wherein aggregating the encrypted, compressed first data block with the rest of the plurality of data blocks comprises appending each data block with a unique header bit-field that indicates a position of a respective data block in a sequence of the plurality of data blocks.

16. The non-transitory computer-readable medium of claim 15, wherein partitioning the data packet into the plurality of data blocks is further based at least in part upon a text pattern analysis of the data packet.

17. The non-transitory computer-readable medium of claim 15, wherein determining, based at least in part upon the first text pattern associated with the first data block, that the first data block comprises the portion that represents sensitive information comprises applying a binary mask to the first data block to identify portions that represent sensitive information, wherein the binary mask isolates the portions representing sensitive information from other portions the first data block.

18. The non-transitory computer-readable medium of claim 15, wherein identifying, based at least in part upon the first text pattern associated with the first data block, the set of repetitive words within the first data block comprises:
extracting a set of features from the first data block based on at least one of a word tokenization or a sentence tokenization, wherein:
the set of features indicates a frequency of occurrence of each word within the first data block; and
the set of features is represented by a feature vector comprising numerical values; and
determining, based at least in part upon the set of features, which words are repeated within the first data block.

19. The non-transitory computer-readable medium of claim 15, wherein the instructions further cause the processor to:
determine that a size of the first data block does not correspond to a size of a second data block; and
resize at least one of the first data block or the second data block such that the size of the first data block corresponds to the size of the second data block.

20. The non-transitory computer-readable medium of claim 15, wherein the instructions further cause the processor to:
receive a second request to decrypt and decompress the encrypted, compressed data packet; and
in response to receiving the second request:
retrieve the encrypted, compressed data packet;
decrypt the encrypted, compressed data packet using a first decryption key;
identify, based at least in part upon header bit-fields associated with the plurality of data blocks, the position of each respective data block within the sequence of the plurality of data blocks;
generate a decrypted, decompressed first data block by:
decompressing the first data block by converting the compressed representation of the set of repetitive words back into the set of repetitive words; and
converting each mapped letter in the portion of the first data block back into a respective original letter based at least in part upon a second decryption key;
reconstruct the data packet by aggregating the decrypted, decompressed first data block with the rest of the plurality of data blocks.
